(19) United States
(12) Patent Application Publication
(10) Pub. No.: US 2026/0016363 A1
(43) Pub. Date: Jan. 15, 2026

(54) METHOD AND APPARATUS FOR LEAK DETECTION

(71) Applicant: PROACTIVE ANALYTICS HOLDINGS (CYPRUS) LIMITED, Limassol (CY)

(72) Inventor: William Alan JEEVES, Bedford (GB)

(21) Appl. No.: 18/880,975

(22) PCT Filed: Jul. 13, 2023
(86) PCT No.: PCT/EP2023/069505

§ 371 Date: Jan. 3, 2025

(30) Foreign Application Priority Data
Jul. 13, 2022 (GB) 2210317.0

(51) Int. Cl. G01M 3/28; F28F 27/00; G01M 3/32

(52) U.S. Cl. CPC G01M 3/2815; F28F 27/00; G01M 3/3254; F28F 2200/00; F28F 2265/16

(57) ABSTRACT

A testing apparatus is designed to test for leakage out of and between first and second conduits, which may be part of a heat exchange system. The apparatus includes first and second channels, a flow control system and flow sensors located at various positions within each respective channel. Each channel connects to a conduit to form respective closed loop systems and the flow control system is adapted to actively maintain fluid pressure at a set level within each closed loop system. In a set-pressure closed loop system, any detection of flow is indicative of a leak. The use of multiple flow sensors at different positions permits differentiation between possible leak locations. Shut-off valves may provide a mechanism by which the testing apparatus can control a sequence of tests to be carried out on the conduits. The apparatus can be used in-line to test a variety of designs of heat exchanger and may be scaled up to test complex systems.

This invention relates to the field of leak detection and, in particular, to leak detection in a conduit that may form part of a heat exchanger.

Heat exchangers are widely used in industry, there being many applications in which heat is required to be transferred from one body to another. They can be categorised by design or function, for example, single- and multi-pass; tubular, plate or extended surface; direct or indirect contact; heaters, coolers and condensers, among many others. If fluids are involved in the transfer process, then a physical barrier must be maintained between them. If a leak develops between the two sides of such a heat exchanger, a food product, for example, may become contaminated or a chemical product will lack the necessary purity. The defective product must then be discarded and the operation shut down while a repair is effected. This is a costly exercise.

Since the development of the first heat exchanger in the 1920s, industry has continued to demand cheaper, more efficient designs with improved system performance. More recently, there has been an additional drive to reduce the carbon footprint. Such demands on design have been met at some cost to reliability, performance and durability. For example, a plate heat exchanger is a much-used design in which the heat exchange area is increased by directing the exchange fluids to flow along the surface of metal plates. Technological developments have led to the plates becoming much thinner, with consequential increases in the risk of manufacturing defects, material defects and of fault development during operation. This latter problem is particularly acute in processes that make use of corrosive fluids, either in production or during a cleaning cycle. This includes the production of many chemicals and foodstuffs and, in such industries, there is a high likelihood of pitting. Moreover, even without corrosive fluids, heat exchanger plates themselves are repeatedly subject to thermal expansion and contraction, potentially leading to work-hardening and the consequential development of splits or cracks.

Test equipment has accordingly been developed that aims to detect a leak within a heat exchanger at an early stage. Various designs are known, with leak detection based on principles ranging from manual inspection to detection of marker or tracer fluids crossing the separating barrier. The vast majority of the known techniques however suffer from a significant drawback: they require the heat exchanger to be mechanically disconnected from the production line and prepared before a leak test can be carried out. This takes time and represents a serious disruption to production schedules. For example, in order to carry out a gas leak test, it can take several hours to prepare the heat exchange system and then over six hours to conduct the actual test. This must be followed by reconnection of the heat exchanger and a full system clean before the heat exchanger can be returned to service. Such a loss in production time is one that plant operators are keen to avoid.

There has more recently therefore been a focus on development of in-line test methods that can be performed without mechanically detaching the heat exchanger and yet retain reliability and accuracy in the detection of defects.

EP 3 740 078 describes in-line test equipment for a complex heat exchange system that is used for milk pasteurisation. A pasteurisation heat exchanger includes heating, cooling and regeneration stages, the latter being a stage in which heat from the treated product is used to provide initial heating of the untreated product. In order to use this test equipment, the complex heat exchange system is fitted with a number of valves, pumps and sensors that are operable by a controller to isolate parts of the system in turn. Each isolated part is then tested in turn for leaks using a pressure decay test. In carrying out this test, one side of the heat exchanger is filled with high-pressure fluid and the other side with low-pressure fluid. If there is a leak across the separating barrier the fluid pressure will change: an increase on the low-pressure side and a decrease on the high-pressure side. If therefore a pressure drop is detected, the conclusion is that a leak is the cause.

Early systems based on the pressure decay principle found that it was difficult to ensure consistency of results: a small leak will give rise to only a relatively small change in pressure, which could be masked by temperature fluctuations in the system. It therefore proved difficult to obtain accurate measurements within a practicable timescale. In order to improve accuracy, the pressure in the high-pressure side of the system described in EP 3 740 078 is maintained at a set level under control of the pumps. This also allows the system to distinguish between a leak across plates and one that may vent to atmosphere, for example from a gasket.

Although in-line testing is advantageous in that it avoids disconnecting the heat exchanger from the process plant, the system described in EP 3 740 078 is very specific in its design of heat exchanger and test equipment. The two components are integrated and the test equipment lacks any flexibility to be used on different types and structures of heat exchanger. Moreover, the method adopted still requires the two sides of the heat exchanger to be charged with a significant pressure differential. Such a high pressure differential is required to ensure sufficient flow through a leak for a detectable pressure change to be observed over a reasonable period of time. The downside however is that a high pressure differential can, over time, damage components of the heat exchanger, in particular the plates.

There is accordingly a perceived need for an alternative system to test heat exchanger integrity that is capable of providing an in-line test capability for a range of heat exchangers with reliable detection of a broad range of defects.

According to a first aspect, the present invention provides leak testing apparatus that comprises:
a first channel with an inflow path and an outflow path that are connectable to spatially separated locations in a first conduit to form a first closed loop system;
a second channel with an inflow path and an outflow path that are connectable to spatially separated locations in a second conduit to form a second closed loop system;
a flow control system including a flow controller in communication with a pump and pressure sensor, the flow control system being in fluid communication with the first and second channels and adapted to pump fluid at a rate that actively maintains pressure at or near a pre-determined level within the first and second closed loop systems; and
a first flow sensor located in the inflow path of the first channel and a second flow sensor located in the inflow path of the second channel.

This design of testing apparatus is based on a radically different approach to prior art methods of leak detection. This present invention looks to detect fluid flow within an otherwise closed channel, such flow therefore being indicative of a leak. This approach is particularly suited to integrity testing of heat exchangers, although it is also suited to other applications that benefit from detection of a leak across a fluid boundary. It allows for numerous advantages. First, pressure is actively maintained in both channels of the heat exchanger, making this system robust against temperature fluctuations either between different parts of the equipment or over the duration of the test procedure. Secondly, the accuracy with which pressure can be maintained in the channels allows for accurate detection of low levels of fluid flow. This means that, in comparison with prior art pressure decay methods, there is no need to generate a high pressure differential across the heat exchange barrier; flow across the barrier can be detected in a sufficiently short timescale with smaller pressure differentials and at pressures far closer to heat exchanger operating conditions. In comparison with prior art integrity testing therefore, use of this present invention means that the testing process itself has a reduced potential for causing damage to the heat exchanger. Thirdly, the only requirement of the heat exchanger is that it has two fluid conduits that can be connected to the testing apparatus. This represents very little practical restriction and so means that this testing apparatus is highly flexible in its application: it can be used with a variety of different heat exchanger constructions and designs, and even with fluid flow apparatus outside the heat exchanger field. In this respect, this present invention may detect a leak of liquid from a hydraulic system and of gas from a pneumatic system. Fourthly, with such a straightforward connection arrangement, the testing system has the flexibility to be used as an in-line testing system, with its connections to the heat exchanger being open or closed, as required. Heat exchangers may be employed in highly critical systems and the level of leakage that a system in accordance with this invention is able to detect and monitor represents a considerable advancement on prior art leak testing systems.

In one embodiment, the leak testing apparatus includes a proportional valve and the flow controller is configured to adjust a control voltage applied to the pump and a degree of opening of the proportional valve in response to a signal received from the pressure sensor in order to maintain pressure in the first and second closed loop systems. This provides an exemplary mechanism by which the pressure is dynamically maintained at its pre-determined level.

Preferably, the leak testing apparatus includes:
a first channel proportional valve and a first channel pressure sensor located in the inflow path of the first channel;
a second channel proportional valve and a second channel pressure sensor located in the inflow path of the second channel; and wherein
the flow controller is configured to adjust a degree of opening of the first channel proportional valve in response to signals received from the pressure sensor and the first channel pressure sensor in order to maintain pressure at or near a first pre-determined level within the first closed loop system;
the flow controller is further configured to adjust a degree of opening of the second channel proportional valve in response to signals received from the pressure sensor and the second channel pressure sensor in order to maintain pressure at or near a second pre-determined level within the second closed loop system; and
the first pre-determined level is different from the second pre-determined level, whereby a pressure differential is maintained between the first and second conduits.

In this embodiment, a mechanism is provided in which a single pump is used to maintain two different conduits at different pressures. Prior art approaches to this problem use two separate pumps, but it has been found that this arrangement can stabilise the system to two target pressures within an acceptable timeframe. Moreover, with experience, it will be possible to set initial starting configurations of the proportional valves and pump voltage that will lead to faster convergence towards the target pressures. That is, the disadvantage of using a single pump will soon be minimal and, in any case, more than compensated in many applications by the reduction in size of a single-pump testing system.

It is much preferred that the leak testing apparatus further includes a third flow sensor located in the outflow path of the first channel and a fourth flow sensor located in the outflow path of the second channel. These additional flow sensors increase the ability of the testing apparatus to differentiate between the various leaks that it may detect. Sensing of a flow in the inflow channel indicates that there is a leak within the corresponding closed loop system. If a corresponding flow is detected in the outflow channel of the other closed loop system, it can be concluded that the leak is across a fluid barrier that separates the two systems. Otherwise, the leak from the first closed loop system will be to atmosphere, for example caused by a leaky valve, gasket or internal connection.

The apparatus preferably includes a respective shut-off valve in each inflow and outflow path. These valves provide a mechanism by which the testing apparatus can control a sequence of tests to be carried out on the first and second conduits.

In the most preferred application of this invention, the first and second conduits are first and second flow paths of a heat exchanger that are adapted for transfer of thermal energy between fluids therein. Heat exchangers are used in many applications and it is often critical to be able to detect a leak at a very early stage. This will particularly be the case if fluid in one path is crossing the boundary to contaminate a quality-controlled product in the other. The testing apparatus of this invention is capable of detecting very small leaks by monitoring flow within closed paths that are set up within the heat exchanger. The information obtained allows an operator of the heat exchanger to determine when best to take the heat exchanger out of operation and repair the leak.

Preferably, the flow controller is a PID (proportional integral derivative) controller. PID algorithms are known and specifically designed for applications in which the controller is required to provide dynamic adjustments to compensate for a continuously changing system. In this application, it is the pressure in each of the two conduits that is maintained at its set value, regardless of the rate of fluid leakage from the system. Use of a PID controller is therefore one way of providing accurate control of the pressure, to the degree required for measuring very small quantities of fluid flow.

In order to implement the PID algorithm, it is preferred that the flow controller includes a microcontroller that is programmed with a PID control algorithm, the flow controller being provided with a first target pressure corresponding to a target pressure to be maintained in the first closed loop system and with a second target pressure corresponding to a target pressure to be maintained in the second closed loop system, the control algorithm having:
a coarse control part that is configured to calculate adjustments of the control voltage applied to the pump and of the degree of opening of the proportional valve in response to the signal received from the pressure sensor, such that said adjustments, when applied to the pump and proportional valve are adapted to maintain pressure in the flow control system at a value that is a function of the first and second target pressures;
a fine control part that operates when the maintained pressure in the flow control system is within a predetermined amount of its target value and that is configured:
   to calculate adjustments of the degree of opening of the first channel proportional valve in response to signals received from the first channel pressure sensor, such that said adjustments, when applied to the first channel proportional valve, are adapted to maintain pressure in the first closed loop system at a value that is within a tolerance range of the first target pressure; and/or
   to calculate adjustments of the degree of opening of the second channel proportional valve in response to signals received from the second channel pressure sensor, such that said adjustments, when applied to the second channel proportional valve, are adapted to maintain pressure in the second closed loop system at a value that is within a tolerance range of the second target pressure; and/or
   to calculate adjustments to the target value of the coarse control part of the PID control algorithm.

This arrangement by which a single PID controller is used to maintain pressure (or indeed any other variable) dynamically at two different target values is believed to be a novel implementation of a PID algorithm. By operating the controller in this manner, the testing system of this invention is able to control pressure in two sides of a heat exchanger with an accuracy that enables first, maintenance of a pressure differential and, secondly, detection of very small flow rates within the testing system. This is despite the changing demands of flow during a test procedure. The pressure stability contributes, in turn, to the accuracy by which a leak within a heat exchanger can be identified by this embodiment of the testing system. Use of a single pump, which is a consequence that follows from the use of the single controller, reduces the size of the testing system, which is an important factor in a practical implementation in which the testing system is installed in line with a heat exchanger.

Each adjustment referenced above is preferably calculated using a PID feedback loop.

In a second aspect, the present invention provides a leak testing system comprising:
a first testing apparatus as described above, the first testing apparatus being connectable to first and second conduits;
a second testing apparatus as described above, the second testing apparatus being connectable to third and fourth conduits to form third and fourth closed loop systems; and
a system management unit configured to provide the first testing apparatus with the pre-determined levels at which pressure is to be maintained in the first and second closed loop systems and to provide the second testing apparatus with the pre-determined levels at which pressure is to be maintained in the third and fourth closed loop systems.

In this aspect, the testing system is scaled up in order to test more complex heat exchangers, with more sections and/or stages and therefore conduits and fluid boundaries to be tested. This makes the testing system hugely flexible in its ability to test the full range of heat exchangers, regardless of their size, design, construction, or complexity. Without limitation, this testing system is capable of testing tubular, plate, extended surface and regenerative heat exchangers; single-pass and multi-pass; gas-to-liquid, liquid-to-liquid and phase-change heat exchangers; two-, three- or N-fluid; indirect and direct contact types; and any heat exchanger with a combination of single- or two-phase convection on either side of the fluid boundary and, indeed, those with combined convection and radiative heat transfer mechanisms.

The respective shut-off valves may be located in each inflow and outflow path of each testing apparatus and the system management unit may be further configured to provide signals to the shut-off valves in both testing apparatus that open and close said shut-off valves in a sequence in accordance with a leak test to be carried out.

To improve application flexibility further, the leak testing system may also include a third testing apparatus, in accordance with the above description, the third testing apparatus including shut-off valves located in each inflow and outflow path and being connectable to fifth and sixth conduits to form fifth and sixth closed loop systems; and wherein the system management unit may be further configured to provide signals to the shut-off valves in the third testing apparatus that open and close said shut-off valves in a sequence in accordance with a leak test to be carried out.

Ideally, the first, second, third, fourth and, if applicable, fifth and sixth conduits each correspond to a flow path in a heat exchanger wherein thermal energy may be transferred between one or more pairs of flow paths.

In a third aspect, the present invention provides a method of testing a fluid conduit for leaks, the fluid conduit being connected to inflow and outflow paths of a first channel of a leak testing apparatus to form a first closed loop system, the method comprising:
a) Pumping fluid through a flow control system to charge the first closed loop system to a pre-determined pressure level;
b) Operating the flow control system to maintain fluid pressure in the first closed loop system at said pre-determined pressure level; and
c) Using a flow sensor to measure fluid flow rate through the inflow path.

This testing method is a novel approach to leak detection within a fluid conduit. Whereas EP 3 740 078 discloses dynamically maintaining a pressure within a conduit, this is for the purpose of improving the accuracy of measurements taken in a second conduit. Moreover, the measurements in the second conduit are of pressure within the system. This present invention is based on the realisation that maintaining pressure in a conduit enables a sufficiently accurate measurement of flow to be made in the same conduit, which finds application in the detection of leaks within the conduit.

In a further aspect, the present invention provides a method of testing a heat exchanger for leaks between first and second fluid conduits, the conduits being arranged in the heat exchanger to enable transfer of thermal energy between fluids therein, the method comprising:
a) Placing the first fluid conduit in fluid communication with a first channel within a testing system, the first channel comprising a first inflow path and a first outflow path, the first conduit and first channel thereby forming a first closed loop system;
b) Placing the second fluid conduit in fluid communication with a second channel within the testing system, the second channel comprising a second inflow path and a second outflow path, the second conduit and second channel thereby forming a second closed loop system;
c) Pumping fluid through a flow control system that is in fluid communication with the first and second inflow paths;
d) Adjusting a first proportional valve in the flow control system, a second proportional valve in the first inflow path and a third proportional valve in the second inflow path such that first and second pre-determined fluid pressures are reached in respective first and second channels, wherein the pre-determined fluid pressure in the first channel is greater than that in the second channel;
e) Maintaining pressure in the first and second channels while closing first, second, third and fourth shut-off valves in the respective first inflow, first outflow, second inflow and second outflow paths;
f) While continuing to maintain pressure in the first and second channels:
   i) Opening first shut-off valve and using a first flow sensor to measure flow in the first inflow path;
   ii) Opening fourth shut-off valve and using a second flow sensor to measure flow in the second outflow path; whereby
   iii) Observing flow in the first inflow path that is above a tolerance level is indicative of a leak from the first conduit and observing flow in both paths that is above a tolerance level is indicative of a leak between the first and second conduit.

This method provides an accurate, flexible and relatively quick way in which an integrity test can be performed on a heat exchanger. It is envisaged that apparatus designed to carry out this method will be installed in line with the heat exchanger and will periodically carry out the test in order to provide a long-term monitoring capability and early detection of leaks. This will enable an operator of the plant or process in which the heat exchanger is operating to assess when best to stop operation and carry out a repair. The speed with which an integrity test can be performed by this method makes it suitable for integration with a production system's clean-in-place (CIP) process. This is a standard procedure that is run periodically by many production systems, either after a set time period to remove normal soiling or when changing over a processing line from one product to another. Testing using this present method is attractive in that the integrity test is relatively quick in comparison with the CIP cycle. The process plant will already have ceased production for the CIP cycle and so the additional loss in production time to carry out the integrity test is minimal.

The method may further include the steps of:
g) While continuing to maintain pressure in the first and second channels:
   i) Opening third shut-off valve and using a third flow sensor to measure flow in the second inflow path; whereby
   ii) Observing flow in the second inflow path that is above a tolerance level is indicative of a leak from the first conduit.

In a still further aspect, the present invention provides leak testing apparatus comprising:
a channel with an inflow path and an outflow path that are connectable to spatially separated locations in a conduit to form a closed loop system;
a flow control system including a flow controller in communication with a pump and pressure sensor, the flow control system being in fluid communication with the channel and adapted to pump fluid at a rate that actively maintains pressure at or near a pre-determined level within the closed loop system; and
a flow sensor located in the inflow path of the channel.

In this aspect, the leak testing apparatus is configured to test for leakage from a single conduit. This expands the application of this invention. Leak testing may be carried out not only on single-conduit heat exchangers, such as a radiator, but also on any fluid-containing system. All that is required is that the conduit under test can be closed off and accessed via connection points to form a closed loop with a testing apparatus channel. The flow control system maintains pressure within the closed loop and any flow that is detected in the inflow path of the channel, indicates a flow out of the loop and hence a leak. This principle of maintaining pressure in an otherwise closed system and monitoring flow is not known in the prior art. The system described in EP 3 740 078 relies on maintaining pressure in one conduit and then taking pressure measurements in a second, different conduit in which pressure is allowed to vary.

The apparatus may also include
a second channel with an inflow path and an outflow path that are connectable to a second pair of spatially separated locations in the conduit to form a second closed loop system, the second pair of spatially separated locations spanning the first pair of spatially separate locations that are connectable to the first channel; and
a second flow sensor located in the outflow path of the second channel; and wherein
the flow control system is further adapted to pump fluid at a rate that actively maintains pressure at or near a pre-determined level within the second closed loop system; whereby
the leak testing apparatus is capable of detecting leakage through valves that may be located in the second closed loop system but not the first.

In this aspect, the testing system is configured to detect leakage across valves. This may be to check that the valves in the second closed loop system are not leaking, which would have implications for an integrity test being carried out on the conduit. The apparatus may also include a first pressure sensor located in the inflow path of the second channel and a second pressure sensor located in the outflow path of the second channel. In this configuration, the apparatus may be used to check for leaks in a single-conduit heat exchanger, such as an air conditioning system. Flow detected in the first channel, may arise through a boundary flow, which would potentially result in a noxious substance being released into the environment, or flow though one or both shut off valves, or a combination of both. The information provided by the pressure sensors together with that provided by the two flow sensors, enables any flow that is detected to be apportioned between boundary flow and leakage across each valve in the second closed loop system. This embodiment therefore is advantageous in determining the likely environmental hazard presented by continued operation of the system under test.

In another aspect, the present invention provides a PID controller adapted to maintain pressure within a hydraulic or pneumatic system that comprises:
a flow control system with a pump, pressure sensor and proportional valve;
a first closed loop system that is in fluid communication with the flow control system and includes a first channel proportional valve and a first channel pressure sensor; and
a second closed loop system that is in fluid communication with the flow control system and includes a second channel proportional valve and a second channel pressure sensor; wherein
   the PID controller is adapted to apply a variable control voltage to the pump and to adjust the degree of opening of the proportional valve and first (and second channel proportional valves; and comprises
a coarse control part; and
a fine control part; wherein
the PID controller is adapted to apply adjustments of the control voltage applied to the pump and of the degree of opening of the proportional valve in response to a signal received from the pressure sensor, said adjustments being calculated by the coarse control part to maintain pressure in the flow control system at a target value that is a function of a first and second target pressures; and
when the pressure sensor indicates a pressure value that is within a predetermined amount of the target value, the PID controller is adapted to:
   apply adjustments of the degree of opening of the first channel proportional valve in response to signals received from the first channel pressure sensor, said adjustments being calculated by the fine control part to maintain pressure in the first closed loop system at a value that is within a tolerance range of the first target pressure; and/or
   apply adjustments of the degree of opening of the second channel proportional valve in response to signals received from the second channel pressure sensor, said adjustments being calculated by the fine control part to maintain pressure in the second closed loop system at a value that is within a tolerance range of the second target pressure; and/or
   adjust the target value of the coarse control part that is a function of the first and second target pressures.

In this aspect, the present invention provides a mechanism by which hydraulic pressure can be maintained in two different closed loop systems with only a single pump. Pressure can be maintained even in the event of a small leak from one or both of the nominally closed systems. This aspect is advantageous for all applications in which it is desirable to reduce the size of the pressure-control system. The pump and its associated electronics together occupy a relatively large space. A controller therefore that can simultaneously pressurise two separate systems using only a single pump therefore presents an attractive option in a number of applications.

The invention will now be described, by way of example only, and with reference to the accompanying drawings, in which:

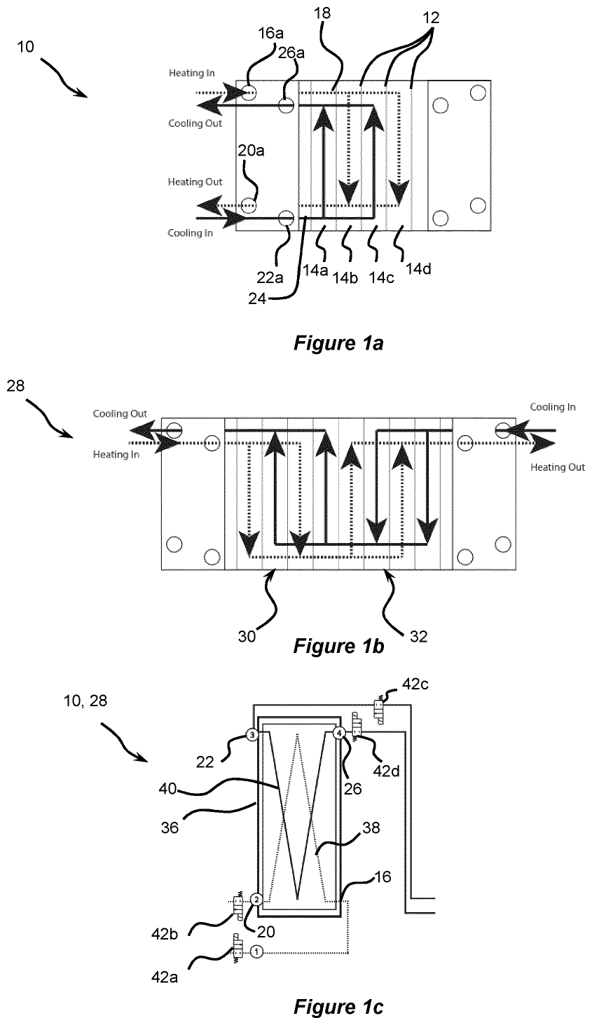

FIG. 1a is a schematic illustration of a generic single-pass single-section heat exchanger;

FIG. 1b is a schematic illustration of a generic multi-pass single-section heat exchanger;

FIG. 1c is a schematic representation of a single-section heat exchanger, as illustrated in both FIGS. 1a and 1b, with connection points shown for attachment to testing apparatus in accordance with this invention;

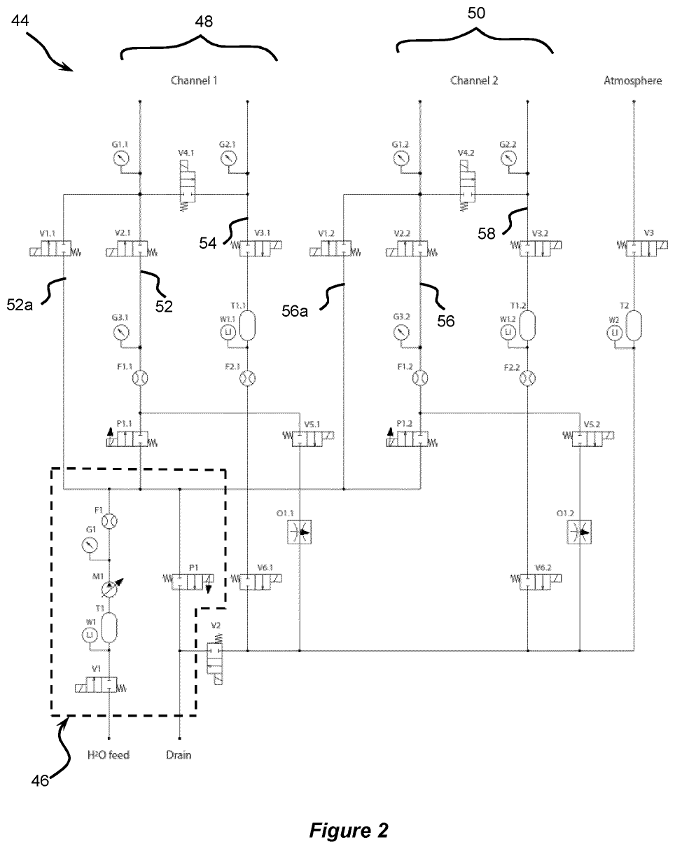

FIG. 2 is a diagram showing the fluid control components of testing apparatus in accordance with this invention;

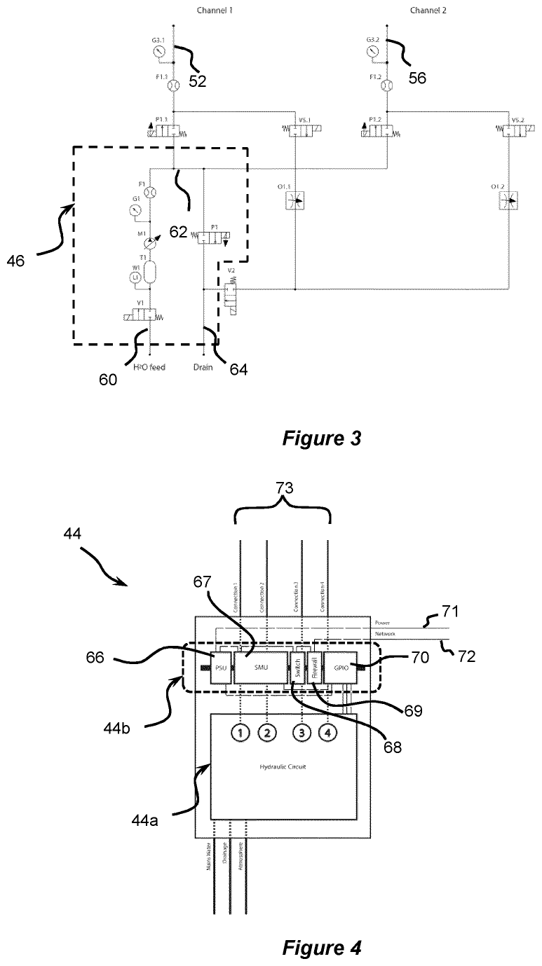

FIG. 3 is a diagram of the flow setting components of testing apparatus in accordance with this invention;

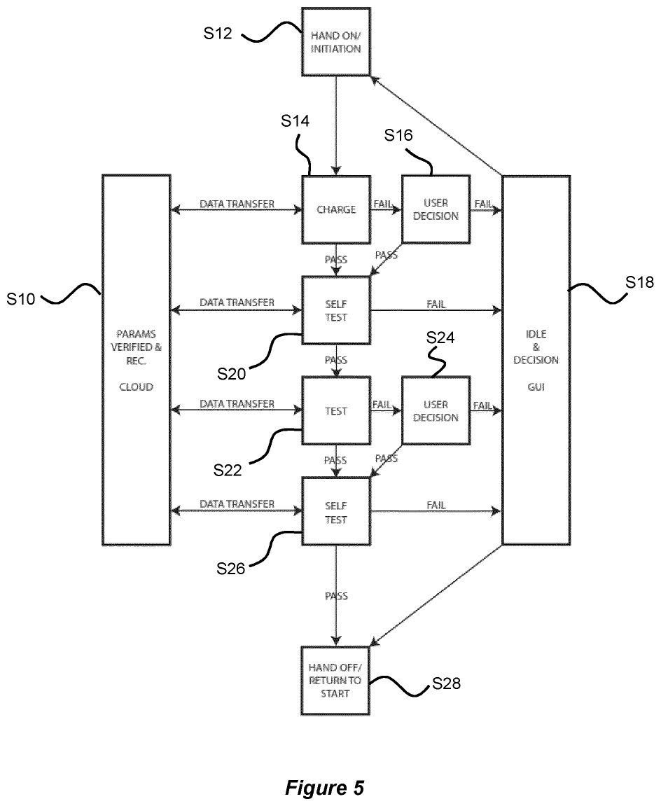

FIG. 4 is a schematic representation of testing apparatus in accordance with this invention, illustrating its control components;

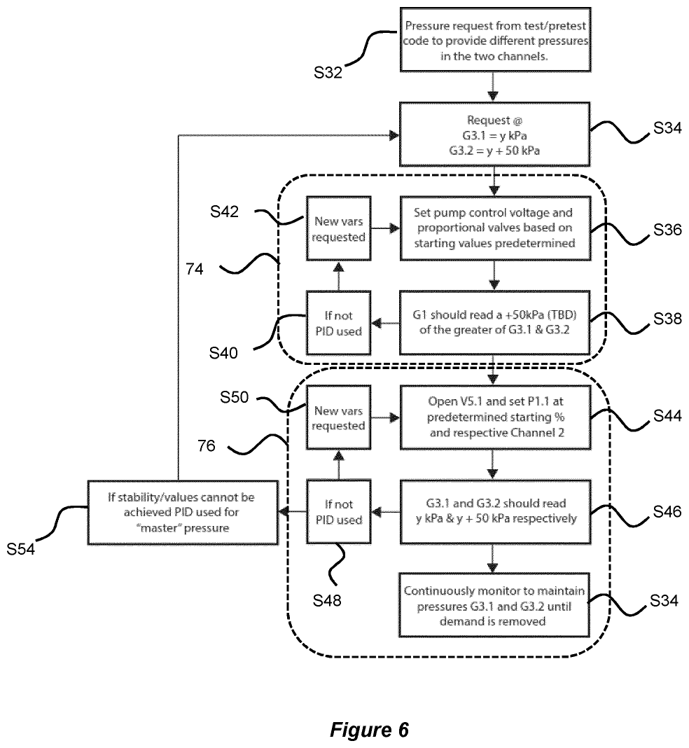

FIG. 5 is a flow diagram representing the steps involved in carrying out a test procedure on a heat exchange system in accordance with this invention;

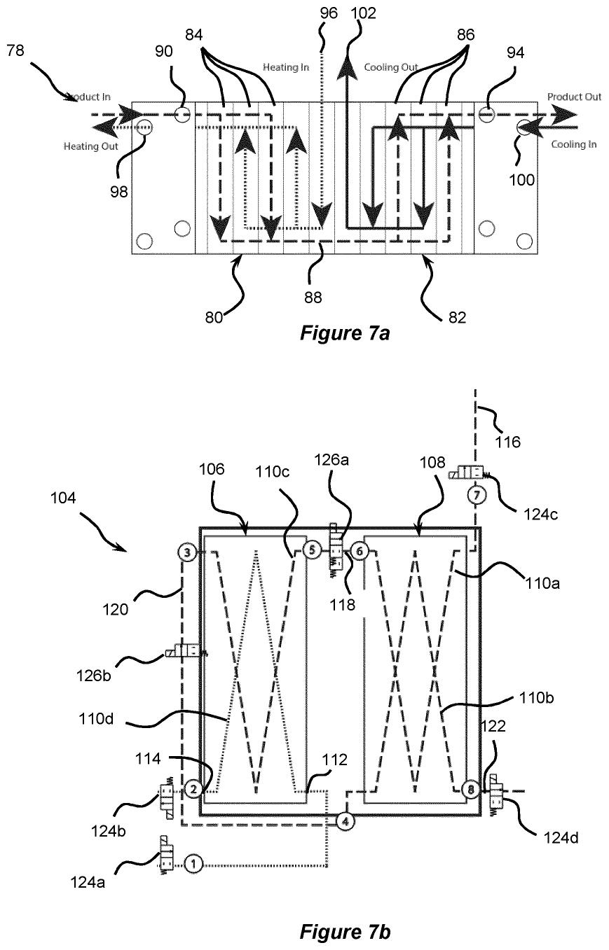

FIG. 6 is a flow diagram representing the steps of an algorithm that may be used to set the flow rate within the test system of this invention;

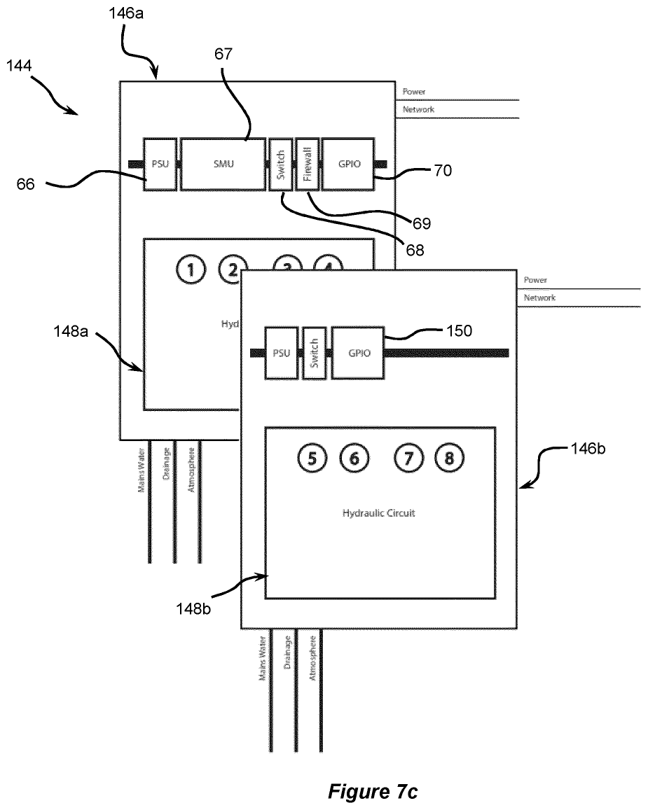

FIG. 7a is a schematic illustration of a generic single-pass two-section heat exchanger;

FIG. 7b is a schematic representation of the two-section heat exchange illustrated in FIG. 7a with connection points shown for attachment to testing apparatus in accordance with this invention;

FIG. 7c is an illustration of the master/slave arrangement of the fluid control components of the testing apparatus of this invention when extended to carry out a test on the two-section heat exchanger of FIGS. 7a and 7b;

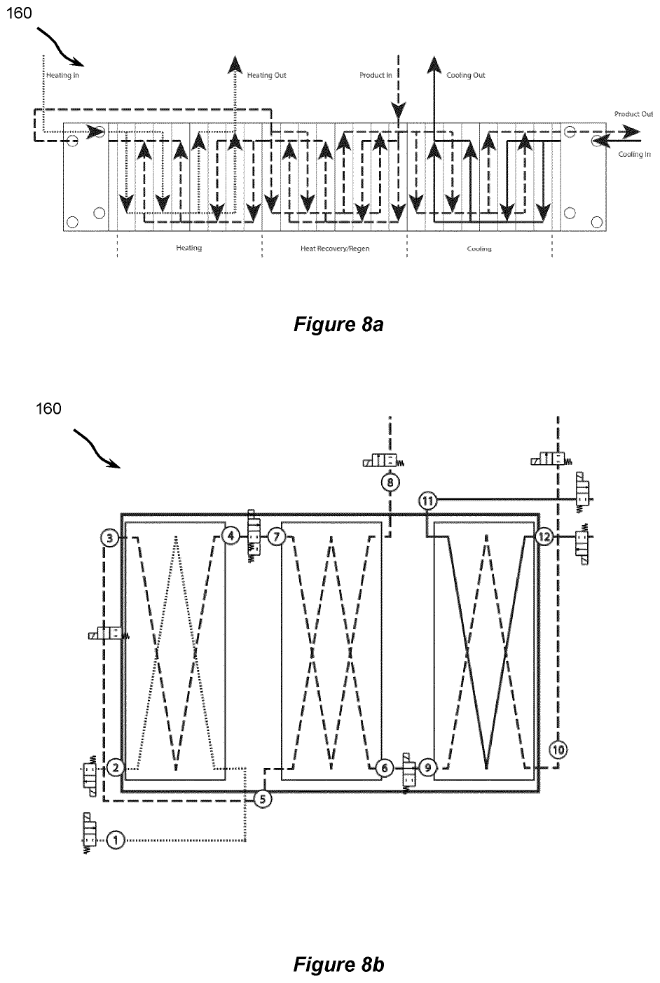

FIG. 8a is a schematic illustration of a complex multi-pass three-section heat exchanger;

FIG. 8b is a schematic representation of the three-section heat exchanger illustrated in FIG. 8a with connection points shown for attachment to testing apparatus in accordance with this invention;

FIG. 8c is an illustration of the master/slave arrangement of the fluid control components of the testing apparatus of this invention when extended to carry out a test on the three-section heat exchanger of FIGS. 8a and 8b;

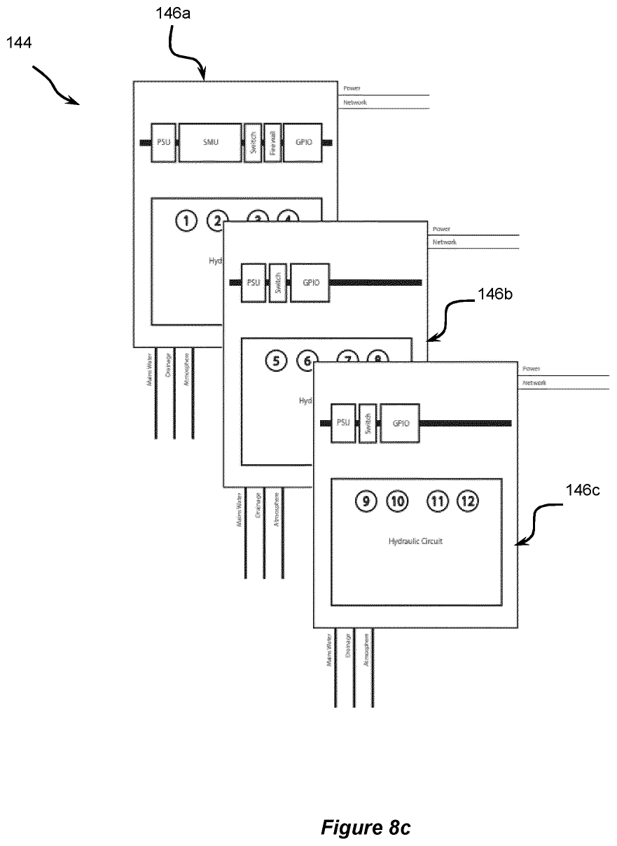

FIG. 9 is a schematic representation of a single-section heat exchanger with connection points shown for attachment to a testing apparatus that is also arranged to test isolation valve integrity; and

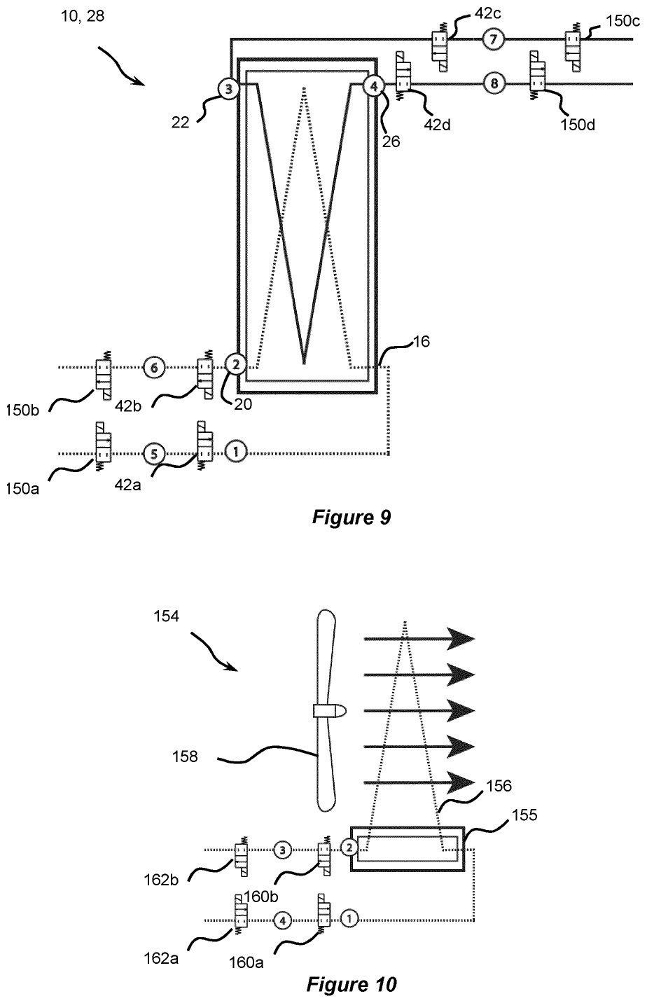

FIG. 10 is a schematic representation of a representative single-pass single-section heat exchanger, with a liquid to gas (atmosphere) boundary, and with connection points shown for attachment to a testing apparatus of this invention.

With reference to FIG. 1a, there is shown a side-representation of a basic plate heat exchanger 10 with one boundary and one section. The boundary is provided by an array of thin metal plates 12 that are spaced apart and sealed with gaskets and the like. The plates 12 therefore define a parallel arrangement of channels 14a, 14b, 14c, 14d therebetween. A heating fluid flow path is defined within the heat exchanger 10: from a hot input 16a, along a link passage 18 (upper part of diagram) through a first set of alternate parallel channels 14b, 14d of those defined by the plates 12 in the array to a hot output 20a. A cooling fluid passage is similarly defined: from a cold input 22a, along a second link passage 24 (lower part of diagram) through a second set of alternate parallel channels 14a, 14c of those defined by the plates 12 to a cold output 26a. As shown in the diagram, this arrangement enables the heating and cooling fluids to flow in opposite directions across the plate surfaces on opposite sides of each plate 12. Each plate 12 therefore provides a large heat-exchange surface area that facilitates heat transfer from the heating to the cooling fluid, while maintaining their physical separation. Terminology may change, depending on the application. For example if a product is being heated within a heat exchanger, the two fluids may be termed heating fluid and product. If the product is cooled, it will be passed through the heat exchanger with a cooling fluid. The essential heat exchange process however remains the same.

FIG. 1b shows a side-representation of a single boundary multi-pass plate heat exchanger 28. This heat exchanger 28 differs from the simpler version of FIG. 1a in that the heating and cooling fluids make two passes through channels defined by plate surfaces. In a first section 30, the flow circuit through the heat exchanger 28 is such that, as in the FIG. 1a exchanger, heating and cooling fluids have opposite flows through adjacent parallel channels defined by a first set of plates. A second section 32 is connected in series with the first 30 and in this section 32 the heating and cooling fluids pass through a further set of adjacent parallel channels defined by a second set of plates. If the first 30 and second 32 sections are of equal size, then the heat exchange surface area is effectively doubled.

The basic heat exchanger represented by the model shown in FIGS. 1a and 1b can vary considerably in size and structure as well as plate material and numbers, depending on the application and fluid media being used. The smallest versions may be found in residential boilers and the largest, used for community heating, may be as large as a building. In industrial applications the two flow paths are generally connected in line with the production facility.

FIG. 1c is a schematic representation of a single stage heat exchanger, such as those illustrated in FIGS. 1a and 1b, typically used in design drawings and the like. The heat exchanger 10, 28 is represented by a rectangular box 36. The two flow paths are indicated by internal V-shaped lines 38, 40 with input (start) 16, 22 and output (end) 20, 26 arranged spaced apart along a width of the rectangular box 36. The lines 38, 40 representing the flow paths intersect twice within the box, representing the transfer of heat energy. Flow path lines 38, 40 continue outside the box 36, indicating fluid flow to and from other parts of the process plant or heating system in which the heat exchanger 10, 28 is incorporated.

The testing system of this invention is designed to be used with any heat exchanger, of any type or complexity. With straightforward adaptation, the heat exchanger as it stands in the production line is modified to allow connection with the testing system. Once the connection is established, the testing system may be used to test the integrity of the heat exchanger at predetermined intervals, or whenever required.

The adaptations made to the heat exchanger are indicated on the schematic of FIG. 1c. Shut-off valves 42a, 42b, 42c, 42d are placed in each input 16, 22 and output 20, 26 line of both flow paths. These valves could be any suitable valve types that are operable to open and close a conduit. For example, they may be 2/2, butterfly, ball or seated valves, whatever may be preferred in the application to which the heat exchanger is put. Connection points \textcircled{1}, \textcircled{2}, \textcircled{3}, \textcircled{4} are then established in each line 16, 20, 22, 26 to the heat exchanger side of the shut-off valves. In some instances the heat exchanger 10, 28 may already have valves and connection points in suitable positions; in others they will have to be built into the in situ heat exchanger. As will be clear from the above, the shut-off valves 42a, 42b, 42c, 42d are positioned such that when they are closed, the heat exchanger is isolated from the rest of the production line in which it is incorporated.

With reference now to FIG. 2, which illustrates fluid control components of a testing system in accordance with this invention, the testing system 44 includes a gear-driven flow setting system (GDFS) 46 along with first 48 (channel 1) and second 50 (channel 2) flow channels. The GDFS 46, which will be described in more detail below, is arranged create a controlled pressure that is maintained within the channels 48, 50 of the testing system 44. Each channel 48, 50 connects to a respective flow path within the heat exchanger under test. For example, when testing a heat exchanger 10, 28 of the type shown in FIG. 1c, channel 1 is connected to the heating flow path 38 at connection points \textcircled{1} and \textcircled{2} and channel 2 is connected to the cooling flow path 40 via connection points \textcircled{3} and \textcircled{4}. The testing system is associated with a process controller (see FIG. 4), for example a microprocessor, that is programmed to control execution of the testing process.

As shown in FIG. 2, the testing system 44 includes the following components:

| | | | |
|---|---|---|---|
| M | Pump | G | Pressure sensor |
| V | Valve | T | Tank |
| M | Water sensor | F | Flow sensor |
| O | Variable orifice | P | Proportional valve |

In the Figure, each component is given a reference symbol of the type Cm or Cm.n, where C indicates the component type, as set out in the table above. Multiple components of the same type within the system or within a particular channel are distinguished using different numbers m. Components that are unique to one or other channel are distinguished by use of a second digit, n, which is either 1 or 2 depending on whether a particular component forms part of the first 48 or second 50 channel respectively.

In general, the heat exchanger 10, 28 will be part of a production system that, during normal operation, is under the control of an industrial process controller. The testing system 44 is connected to the heat exchanger but its valves are closed, along with any hygienic shut-off valves that may be a part of and under the control of the production system. The testing system 44 therefore remains isolated from the production system. When testing is scheduled to be carried out, the industrial process controller will close the shut-off valves 42a, 42b, 42c, 42d in order to isolate the heat exchanger from the rest of the production system. The heat exchanger 10, 28 thereby becomes a “closed system” and should fluid flow be detected leaving the system, it will be considered “exit flow” that arises through a defect in one or more of the system boundaries.

Following isolation of the heat exchanger/testing system, the testing process controller takes over control and turns on the GDFS 46 to pump water through the system. Alternative test fluids, for example isopropyl alcohol, may be used in certain applications but it is envisaged that water will be most common and so water will be used as the example in this description. If, at the time of test initiation, the heat exchanger paths 38, 40 are not charged with fluid, the testing process controller will open valves V1.1 and V1.2 that are in respective bypass flow paths 52a, 56a. These valves V1.1 and V1.2 allow a relatively high throughput of water and so facilitate charging of the heat exchanger up to an initial starting pressure in a reasonable time period. Once the heat exchanger 10, 28 is charged with water, valves V1.1 and V1.2 are closed and the remaining valves in the testing system 44 are opened ready to equilibrate to a testing pressure. Flow is governed by the GDFS 46 such that pressure within the flow paths 38, 40 builds up to and is then maintained at a user-selected value that is required for the test. Importantly, the pressure at which the test is carried out may be around the operating pressure of the production system. In such an embodiment, there is no requirement to charge the heat exchanger to a pressure significantly above that at which it normally operates.

By way of illustration of flow paths within the testing system 44, consider the situation in which channel 1 is connected to an external conduit, for example a path through a heat exchanger, and fluid is pumped through the circuit established. As will later become apparent, during the testing process itself, there may or may not be any flow within the circuit and this description is therefore provided simply in order to illustrate the function of the components of the system and how the testing system 44 has the potential to support fluid flow within. Valves V2.1 and V3.1 set the normal flow direction within the channel: along an inflow path 52 to, in this example, connection point \textcircled{1} of the heat exchanger, through the heat exchanger to connection point \textcircled{2}, and then a return flow through the testing system along outflow path 54. The outflow path 54 leads to a tank T2 that so functions as an expansion vessel to maintain pressure within the system 44. A water sensor W2 monitors the volume of water in the tank T2 and if the level rises too high, sends a signal to the testing process controller, which then turns off the GDFS 46 and opens valve V2 to allow air to be drawn in. Proportional valve P1.1, in conjunction with valve V5.1 and orifice O1,1, are adjusted to set the rate at which water pumped by the GDFS 46 flows along the inflow path 52 of channel 1, which is monitored by flow sensor F1.1. Flow sensor F2.1 is configured to monitor flow rate in the outflow path 54.

Similarly, channel 2 also has the potential to support fluid flow through an external conduit. One-way valves V2.2 and V3.2 set the direction of flow: along an inflow path 56 to, in this example, connection point \textcircled{3} of the heat exchanger, through the heat exchanger to connection point \textcircled{4}, and then a return to the testing system along outflow path 58, which is open to atmosphere. Proportional valve P1.2, in conjunction with valve V5.2 and orifice O1.2, are adjusted to set the rate at which water pumped by the GDFS 46 flows along the inflow path 56 of channel 2. Flow sensors F1.2, F2.2 are configured to monitor flow rate along the inflow 56 and outflow 58 paths respectively.

The operation of the GDFS 46 will be explained in more detail below but essentially, proportional valves P1, P1.1 and P1.2 are adjusted to control flow rate until the system settles at the required pressures. These pressures are such that a pressure difference is maintained between the two channels 48, 50 through the relative degree of opening of P1.1 and P1.2. Equilibrium is reached when the flow rate through proportional valves P1.1 and P1.2, which is driven by the GDFS 46 and proportional valve P1, balances the pressure of water in the respective testing channels 48, 50 and the heat exchanger flow paths 38, 40. Excess flow through P1.1 exits the system through valve V5.1 and variable orifice O1.1. If there are no leaks from the heat exchanger, water within the heat exchanger 10, 28 and in channel 1 downstream of a connection node with valve V5.1 is static and no flow is observed at either flow sensor F1.1, F2.1 in this testing system channel 48. Similarly, excess flow through P1.2 exits the system through valve V5.2 and variable orifice O1.2. If there are no leaks, water within the heat exchanger 10, 28 and in channel 2 downstream of a connection node with valve V5.2 is static and no flow is observed at either flow sensor F1.2, F2.2 in this testing system channel 50. If there is a leak however, flow will be observed through one or more of these flow sensors F1.1, F2.1, F1.2, F2.2.

By way of example, consider testing the heat exchanger shown in FIG. 1c using the testing system of this invention. The flow sensors F1.1, F2.1, F1.2 and F2.2 measure the flow through connection points \textcircled{1}, \textcircled{2}, \textcircled{3} and \textcircled{4} respectively. If there is a leak from the heating flow path 38, for example from a leaky seal or gasket then, in order to maintain equilibrium pressures within the system, there must be additional flow into connection point \textcircled{1} that balances the loss from channel 1 through the leak. Accordingly flow will be observed at flow sensor F1.1. Similarly, a leak to atmosphere in the cooling flow path 40 will result in an equilibrium flow being detected at flow sensor F1.2 (connection point \textcircled{3}). If, on the other hand, there is a leak across the boundary of the heat exchanger 10, 28, then there will be a boundary flow from the higher pressure channel (for example the heating flow path 38, which is connected to channel 1) to the lower pressure channel (cooling flow path 40). Under equilibrium conditions in this situation, there will be a flow into connection point \textcircled{1} that balances the loss from channel 1 arising from the leak and a flow out of connection point \textcircled{4} that balances the increased flow into channel 2. The testing system 44 will therefore observe non-zero flow readings on both sensors F1.1 and F2.2. These differing observations indicate how the flow rate measured at these four flow sensors F1.1, F2.1, F1.2, F2.2 enables first detection of a leak and, secondly, identification of the location of the leak i.e. is it across the boundary or through a gasket or seal.

In its standard mode of operation, the testing system 44 allows flow from the inflow path 52, 56 to connection points \textcircled{1} and \textcircled{3}, through the heat exchanger, and then from connection points \textcircled{2} and \textcircled{4} to the outflow path 54, 58. Flow direction can be reversed however by opening valves V4.1 and V4.2. Flow from the proportional valve P1.1 is then diverted through valve 4.1 to the channel arm that links to connection point \textcircled{2}. This results in flow through the heat exchanger 10, 28 in the reverse direction to connection point \textcircled{1}, from which flow is again diverted through valve 4.1 to outflow path 54. A similar reversal of flow through connection points \textcircled{3} and \textcircled{4} is observed in channel 2. This flexibility is advantageous is testing more complex multi-section heat exchangers, in which access may not be available at all preferred connection points.

It will be noted that regardless of the direction of flow through the heat exchanger 10, 28, a leak will be observed as an in flow through flow sensor F1.1 or F1.2 and/or an out flow through flow sensor F2.1 or F2.2.

The testing system 44 of this invention is designed to detect very small leaks within the heat exchanger 10, 28. It will of course be apparent that if the leak is small, then any observed equilibrium flow rates will also be small. It follows therefore that accurate flow sensors are needed to measure flow rates within the testing channels 48, 50. Suitable examples for use with this invention are available from Sensirion, who supply a range of flow sensors that are capable of measuring flow rates in the millilitre and microlitre per minute ranges. These sensors are based on a thermal transfer principle. Each sensor is essentially a tubular structure with a central pressure-stable membrane. A heating element is located in the centre of the membrane, with temperature sensors placed both on its upstream side and on its downstream side. If there is flow along the bore of the tube, through the membrane and heating element, liquid passing along the tube transfers heat from the heating element and a temperature increase is observed at the downstream sensor. Flow rate can be deduced from the development of a temperature differential between the upstream and downstream sensors.

The flow sensors are calibrated for use with a specific fluid, in this case water. Tanks T1.1 and T1.2 are filled with water and located in the outflow paths 54, 58 in order to ensure that it is water that flows through the sensors. This arrangement therefore mitigates the risk of alternative liquids flowing from the heat exchanger under test and corrupting the flow sensor readings.

In some applications of this invention, a different test fluid may be supplied by the testing system and used for leak detection. For example, the test fluid may be a liquid such as glycol, isopropyl alcohol, or liquid natural gas (LNG). Alternatively, it could be a gas such as methane, argon, nitrogen, steam or a refrigerant gas such as R32 (difluoromethane). In such embodiments, the tanks T1.1, T1.2 are filled with the alternative test fluid and the flow sensors are calibrated for use with this fluid.

In addition to accurate measurement of flow rate, it is important that pressure fluctuations within the system do not give rise to flows that mask any leakage. For this reason, the testing system 44 of this invention is designed to maintain a precise pressure within the heat exchanger 10, 28.

Such pressure control is achieved using the GDFS control system, which will now be described with reference to FIG. 3.

FIG. 3 shows the GDFS 46 and inflow paths 52, 56 of the two channels of the testing system 44. At the heart of the GDFS 46 is a voltage-controlled pump M1 that operates in tandem with proportional valves P1, P1.1 and P1.2 and a feedback loop that is controlled by the testing process controller in accordance with a pre-programmed PID (proportional integral derivative) algorithm. Valve V1 opens and closes a feed line 60 into tank T1. Water (or other fluid to be used in the test) is drawn from the tank T1 by the pump M1 and fed to an output line 62. The output line has three branches: the first two form respective channel inflow paths 52, 56 and the third 64 is a flow path through the proportional valve P1, which leads to a drain. The total flow in the output line 62 is monitored by flow sensor F1 and the pressure by pressure sensor G1. In the first instance, flow rate of pumped fluid is determined by the operating voltage on the pump M1 and the degree of opening of the proportional valve P1. The proportion of fluid pumped by pump M1 and that leaves the system via flow path 64 is controlled by the aperture size within the proportional valve P1. The larger the opening, the more fluid is drained from the system, and flow into the testing channels 52, 56 is reduced. Conversely, reducing the degree of opening of the proportional valve P1 increases flow rate into the testing channels 52, 56. In a similar manner, the degree of opening of proportional valves P1.1 and P1.2 determines the proportion of flow into the respective testing channels 52, 56. Excess flow is drained via orifices O1.1 and O1.2, under the control of valves V5.1 and V5.2. Throughout the integrity test procedure, the voltage on pump M1 and opening degree of valves P1, P1.1 and P1.2 are continually adjusted using the PID control algorithm. The pressure in the system 44 is continually monitored in the pump output line 62 by pressure sensor G1 and in channels 1 and 2 52, 56 by pressure sensors G3.1 and G3.2 respectively. This provides a dynamic control by which flow rates through the system are maintained regardless of any changing demands placed on flow by any leaks within the system. Details of the algorithm will be described in more detail later but essentially the operating pressure is first approached by closing valves P1.1 and P1.2 and directing all pumped fluid to output flow path 64. The voltage on pump M1 and degree of opening of valve P1 are set to their initial values. With experience, approximate values in order to stabilise at an operational pressure within a particular system under test will become known and so the time taken to reach equilibrium will be reduced. In any case, the pressure at sensor G1 is noted for these values of the initial voltage and valve orifice size. If the pressure at G1 is above the target pressure, then first the pump voltage and then the opening of P1 are adjusted by amounts determined by the PID algorithm in order to reduce the pressure in the system. Likewise, if the measured pressure at G1 is below the target pressure, pump voltage may be increased and/or the orifice size of proportional valve P1 reduced in order to increase the pressure within the system. After repeating these steps in a series of feedback loops, the pressure measured at G1 will move within a certain range (for example 100 Pa) of the target pressure. At this point, proportional valves P1.1 and P1.2 are opened, along with valves V5.1 and V5.2, and pressures measured on G1, G3.1 and G3.2. For this stage, the target pressures are those in the two testing channels 48, 50 i.e. as measured at pressure sensors G3.1 and G3.2. The PID control loops are repeated in order to move the G3.1 and G3.2 pressures towards their target values.

This technique of constantly adjusting the pump M1 voltage and opening of proportional valves P1, P1.1, P1.2 allows a very accurate pressure to be maintained within the testing system and connected heat exchanger. Pressure is monitored and adjusted independently of any flow within the system and so pressure is maintained at the required level irrespective of any leak.

The testing system 44, as shown in FIG. 4, includes both hydraulic 44a and control 44b components. The above description focuses on the hydraulic components 44a and the control components 44b will now be described in more detail. As illustrated in FIG. 4, in one embodiment, the control components include a power supply unit 66, a testing system management unit (SMU) 67, a switch 68, firewall 69 and a GPIO unit 70. A power supply line 71 connects the power supply unit 66 to an electricity source, such as a mains distribution network. All control components 66-70 are connected to an information network 72, such as the internet, LAN or similar.

The SMU 67 is a central processing unit on which is stored software necessary for overall management of the testing process. This includes software specifically directed towards analysing data, processing user-inputs, operating a user interface, communicating with cloud-based instructions, communicating with a GPIO unit 70 and overall management of the testing system 44. The GPIO unit 70 includes a microcontroller and associated connections for the various sensors and control valves that are incorporated in the hydraulic section of testing system 44a of which it is a part. In particular, the microcontroller is programmed with firmware instructions that enable it to operate as a PID controller in pressure-setting algorithms using the GDFS 46. Further firmware instructions enable the GPIO unit 70 to receive and decode information from sensors and the SMU 67.

In the representation of the testing system 44 shown in FIG. 4, connection points \textcircled{1}, \textcircled{2}, \textcircled{3} and \textcircled{4} are indicated in positions on the hydraulic circuit 44a, with connecting pipes 73 that, in operation, link to the channels in the heat exchanger 10, 28.

As indicated above, the testing system of this invention has the ability to set up and accurately maintain pressure and is also capable of measuring small flow levels. These features, alongside the control methodology that is available, enable the testing system 44 of this invention to carry out integrity tests on many different types and varieties of heat exchange systems. Indeed, the testing system 44 may be used to test for leaks across any fluid boundary and is not restricted to testing boundaries within a heat exchange system. An example of a protocol that may be followed in carrying out a test on a heat exchanger component of an industrial process line will now be described with reference to FIG. 5.

At step S10, the parameters of the test are retrieved over the network connection 72 from a data storage facility. Typically, the storage facility will be a repository in the cloud that is administered by the test provider. This will be a database in which heat exchanger type and details of the industrial process in which it is used are stored alongside test parameters such as charging pressures, pressure differential, positions at which flow measurements are to be taken, order of measurements, tolerances for error alerts, etc. Alternatively, the test parameters can be stored locally and administered by the facility controller, but this loses the opportunity to benefit from updated information derived from testing procedures run by similar testing equipment at other facilities. In either case, the test parameters are retrieved S10 by the testing system management unit (SMU) 67 and verified as correct for the heat exchanger under test. At step S12, the facility or production line process controller closes the shut-off valves 42a, 42b, 42c, 42d and hands over operational control of the now-isolated heat exchanger to the SMU 67. A first step S14 in carrying out a test is to charge the testing system to the required volume of fluid. In other words, to build up to pre-determined set pressures at sensors G1.1 and G1.2. These will vary from system to system but, in the majority of cases, will be similar to the operating pressures experienced by the heat exchanger in its production line. For example, 8 bar pressure in the product side (at G.1.1) and 7.5 bar in the coolant side (at G1.2), leaving a pressure differential of 0.5 bar. If the system fails to reach a stable pressurisation in an acceptable time period, this is notified to a user, who may then take the decision S16 to abort the test. Any test failure returns S18 the testing system 44 to an idle mode and presents the user with an interface to confirm a report of the causes of failure. Such cause of failure may, for example, be a catastrophic leak within the system or a failure in the isolation of the heat exchanger. Alternatively, if no such reason for the failure is found, the user can choose to override this alert and continue with the test.

In order to repair a leak, the heat exchanger must be dismantled and this incurs significant loss of production time. It is clearly important therefore to be sure that if a leak is detected by a testing system, it is not caused by a defect in the testing system 44 itself. For this reason, in one embodiment, the system of this invention is designed to carry out a self test S20 immediately after successful charging. Once charged, the testing system may be isolated from the heat exchanger and with reference to FIG. 2, the testing system valves V1.1, V2.1, V3.1, V4.1, V1.2, V2.2, V3.2, V4.2 that are in channels 48, 50 that connect with the heat exchanger are all closed. At this point the system is being charged to a stable pressure by the GDFS 46. This pressure will be to the higher end of the range provided by the GDFS 46 and will be the same in both channels. Flow through the GDFS is noted using flow sensor F1 and pressures are monitored using pressure sensors G1.1, G2.1, G3.1, G1.2, G2.2, G3.2. As a first part of the self test, and after a short stabilisation time, flow sensors F1.1, F1.2 in the inflow paths 52, 56 checked. Detection of flow on either flow sensor F1.1, F1.2 is indicative of a leak within the respective inflow valve V2.1, V2.2. Inflow path 52, 56 valves V2.1, V4.1, V2.1, V4.2 are opened and then flow sensors F2.1 and F2.2 in the outflow paths 54, 58 are checked for any indication of flow. If flow is detected, it is attributed to a leak in respective outflow valves V3.1, V3.2. As a final part of the self test, inflow path valves V2.1, V4.1, V2.1, V4.2 are closed again and the bypass valves V1.1 and V1.2 are tested to ensure their integrity. If a leak is detected at any stage, the self test is failed and the testing system 44 returns S18 to its idle mode.

Only if the testing apparatus 44 passes all stages of the self test, is it permitted to start the leak test at step S22. If it fails at any stage, the testing apparatus 44 returns to its idle phase S18 and an alert is sent to the user. Until the cause of the self-test failure is determined and repaired, heat exchanger integrity cannot be tested by this system 44.

At step S22 the testing system 44 carries out the test of the heat exchanger 10, 28 to which it is attached. There are many options for the sequence in which the valves within the testing system 44 may be opened and closed in order to detect and localise any leaks within the heat exchanger, but, in this embodiment, the routine adopted in order to test a single boundary heat exchanger 10, 28 is as follows. Again with reference to FIG. 2, valves V2.1 and V2.2 in the channel inflow paths 52, 56 are both opened, which puts the two halves of the heat exchanger in fluid communication with the testing apparatus 44. Once a stable flow is observed in the GDFS 46 at flow sensor F1, flow sensor F1.1 is checked for an indication of flow along the channel 1 inflow path 52. If any flow is observed, there is a defect in that path of the heat exchanger 10, 28 to which this channel 1 is connected (connection point \textcircled{1}, into the heating path 38 in the example of FIG. 1c). Next, the valve V3.2 in the second channel outflow path 58 is opened and flow sensor F2.2 checked for any indication of flow in this channel. In other words, whether there is a corresponding flow out of the cooling path 40 and connection point \textcircled{4}. If flow is detected at both flow sensors F1.1, F2.2, this is indicative of a defect at the heat exchanger boundary. If it is only detected in the inflow channel flow sensor F1.1, the defect is in some other part of the isolated path under test (heating path 38 in this example) of the heat exchanger 10, 28. If the defect is across the boundary, the test may be stopped: the heat exchanger has failed and the leak has been identified and isolated. Otherwise, or if there is a requirement to investigate the possibility of further leaks, the flow sensor F1.2 in the second channel inflow path 56 is checked. If a flow is detected, this is indicative of a leak in that path of the heat exchanger 10, 28 to which this channel 2 is connected (connection point \textcircled{3}, from the cooling path 40 in the example of FIG. 1c). For the final part of the flow test, the valve V3.1 in the first channel outflow path 54 is opened and flow sensor F2.1 checked for an indication of flow in this channel. In other words, a check is made as to whether, in the case of a flow into channel 2, there is a corresponding flow out of the heating path 38 and connection point \textcircled{2}. If flow is detected at both flow sensors F1.2, F2.1, this is indicative of a defect at the heat exchanger boundary. If it is only detected at the inflow channel flow sensor F1.2, the defect is in some other part of the cooling path 40. If at the end of this procedure, no flow has been detected in any of the inflow 52, 56 or outflow 54, 58 channels of the testing system 44, then the heat exchanger 10, 28 has passed its integrity test.

In the event that flow is detected at any flow sensor F1.1, F1.2, F2.1, F2.2 during the heat exchanger integrity test, the testing system 44, at step S24, presents details of the observed flow to the user. This provides the user with the opportunity to assess the severity of the leak and decide whether action should be taken. In some applications, a small leak through a seal or gasket but not across the boundary may be acceptable. A user may therefore set parameters within the testing system 44, which determine a level of detected flow that is acceptable. In such cases, the heat exchanger can continue to be used in the industrial process. If the detected flow is above an acceptable tolerance then the user confirms failure of the integrity test by that heat exchanger 10, 28. The testing system 44 then returns to its idle state S18. Otherwise, the user can indicate that the test is passed, perhaps with certain cautions going forward. In some embodiments of the invention, test results are communicated to a cloud-based server for storage and further analysis.

In order to verify the test results, the testing system 44 will then carry out a second self test at step S26. This checks that the testing system has not been compromised during the actual test of the heat exchanger. After completion of this second self test S26 or subsequent to any failure S18 of any part of the testing sequence, the testing system process controller hands back control S28 to the industrial process controller. The test cycle is complete.

In the above description reference is made to a user of the testing system 44. Such a user may be a person on the site of the industrial process, perhaps one who is responsible for overseeing performance. Alternatively, the user may be remote, for example a person who is unconnected with the entity running the industrial process but who is experienced in testing procedures using testing systems 44 of this invention. Such a user will generally have access to test results from installations of a number of such testing systems 44 in a variety of industrial settings and locations. This arrangement is therefore advantageous in that it provides the opportunity to amass data on a number of tests and systems and so to enable, perhaps with the assistance of a machine learning algorithm, better interpretation of results. This may further enable heat exchanger failures to be predicted and preventative repair undertaken at an appropriate time.

As will be understood from the foregoing description, critical to the reliability of results is the ability of this testing system 44 to maintain set pressure levels within both halves 38, 40 of the heat exchanger to a high degree of accuracy. FIG. 6 is a flow chart showing an example of a PID control algorithm that may be used to operate the GDFS 46 such that a stable pressure is maintained in the heat exchanger system at pre-selected values. The algorithm is essentially made up of two parts: a coarse control part 74 and a fine control part 76.

In order to begin charging the system 44 to test pressure, the SMU 67 must be provided with the required target information. This will be in the form of two channel pressures, one for channel 1 and a second for channel 2, at which the heat exchanger test is to be performed. These pressures will generally be close to those that replicate conditions in the heat exchanger during its normal operation. A pressure differential must be maintained between the two channels in order for there to be flow in the event of a leak at the boundary. A first step S32 is therefore a request from test/pre-test code to provide different pressures in channels 1 and 2. The SMU 67 receives this request and passes target pressure information, in the form of target values for pressure sensors G3.1, G3.2 in the channel inflow paths 52, 56, to the GPIO unit 70. This is because it is the GPIO unit 70 that is responsible for the PID pressure control algorithm. By way of example only, and as an aid to illustration, it is assumed that a pressure differential of 50 kPa is to be maintained. That is, if the target pressure at channel 1 pressure sensor G3.1 is y kPa, that at the channel 2 sensor G3.2 will be (y+50) kPa.

With reference to both FIGS. 2 and 6, at Step S36 the control voltage on the GDFS pump M1 and the opening size of the GDFS proportional valve P1 are set. Initially, these will be predetermined start values. At this stage, all valves V1.1, V2.1, V3.1, V1.2, V2.2, V3.2, V5.1, V5.2 in the testing system channels are closed and the GDFS 46 pump is operated with these flow circuit parameters and a reading is taken from GDFS pressure sensor G1. At step S38, this reading is compared with the target value and an error value is derived. At this stage, prior to opening the testing channel valves V5.1, V5.2, the target pressure for the GDFS pressure sensor G1 must be higher than both the two target values for pressure sensors G3.1 and G3.2. Again by way of example only, and not to be seen as a limitation on this algorithm, the target pressure for sensor G1 is set at 50 kPa higher than the larger of the two target values for pressure sensors G3.1 and G3.2. That is, the target pressure for sensor G1 is (y+100) kPa. The next step depends on whether the pressure at G1 is within a pre-determined range of its target, for example within ±10 kPa of (y+100) kPa in this example. If the G1 pressure is outside this range (i.e. the error value is >10 kPa), the algorithm moves to step S40 and makes a PID calculation based on the size of the error value and pre-set values for a first set of proportional, integral and derivative gains in order to determine the adjustment to make to the control voltage that is applied to the GDFS pump M1 and/or to the degree of opening of the proportional valve P1. At step S42, the adjusted values of pump voltage and valve opening are applied to the pump M1 and proportional valve P1 of the GDFS 46. The process then returns to step S36 and the GDFS 46 pump is operated with these revised flow circuit parameters and a new reading is taken from GDFS pressure sensor G1. These steps S36 to S42 are repeated until the G1 pressure falls within the predetermined range (±10 kPa) of its target ((y+100) kPa). Once this target is sufficiently close, the PID algorithm moves on to its fine control part 76.

At Step S44 the proportional valves P1.1, P1.2 of channels 1 and 2 are opened by a set degree. Initially, the opening will be by predetermined amounts, with the valve in the higher-pressure channel being opened further. Valves V5.1 and V5.2 are opened to allow flow through the proportional valves P1.1, P1.2 to exit the system. The GDFS 46 is then operated with the pump voltage and GDFS proportional valve P1 opening maintained from the coarse control 74 part of the PID algorithm and with the channel proportional valves P1.1, P1.2 opened to their set degree. Readings are taken from the flow channel pressure sensors G3.1, G3.2. At step S46, these readings are compared with their target values, for example y kPa for G3.1 and (y+50) kPa for G3.2 and respective error values are derived. If one or other error value lies outside a certain range, for example the target pressure±1 kPa, the algorithm moves on to step S48. At Step S48, for each individual pressure (G3.1, G3.2) reading, a PID calculation is performed to generate an adjustment to the opening of the respective proportional valve P1.1, P1.2. The adjustment calculation is based on the respective pressure error value and pre-set values for a second set of proportional, integral and derivative gains. At Step S50, the adjustments calculated at Step S48 are made to the opening values of the channel proportional valves P1.1, P1.2. The process then returns to step S44, the proportional valves P1.1, P1.2 of channels 1 and 2 are opened by their adjusted degrees and updated readings taken from the flow channel pressure sensors G3.1, G3.2. These steps S44 to S50 are repeated until the G3.1 and G3.2 pressures fall within the predetermined range (±1 kPa) of their respective targets (y kPa, (y+100) kPa).

Once the target pressures are reached in both channels, the pressures at flow channel pressure sensors G3.1, G3.2 are continually monitored S52 and consequential adjustments made S48, S50 to the flow channel proportional valve P1.1, P1.2 openings in order to actively maintain these pressures close to their target values.

At Step S54 a check is performed after a set number of iterations of PID loop S44-S50, in order to verify that the pressures at flow channel sensors G3.1, G3.2 are converging towards their target values. If there is no convergence, the algorithm returns to the coarse control part 74 and attempts to repeat S34 the PID pressure stabilisation routine with new values of pump M1 control voltage and opening of the GDFS proportional valve P1.

This use of a PID control loop to actively maintain two different pressure levels is a novel implementation of this algorithm. A more typical approach, and one that is known in the prior art, is to use two separate pumps, one for each channel 48, 50. Each pump is associated with a respective proportional valve and PID control loop, enabling the pressure in each channel 48, 50 to be independently maintained at its target value. However, the use of a single pump and PID controller to stabilise pressure in two flow channels is advantageous in reducing the size of the testing system. This is an important consideration in the take up of a testing system 44 that is to be permanently connected to the heat exchanger but that will only be used periodically. The disadvantage is that with more adjustable components, the PID loop will take longer to stabilise the system. That is, in the initial stages at least, there is a trade off to be made between cost and size of the testing system with the time it takes to run a test sequence. With the system of the present invention however, data is shared centrally and so it is to be expected that, over a relatively short period of time, it will be possible to access initial pump and valve settings that will be reliably close to their operating values. Convergence to the target pressures will therefore be quicker, largely negating the disadvantage of the longer stabilisation period for two flow channels.

The testing system 44 described above can be scaled up for use with more complex heat exchangers with multiple sections and therefore multiple boundaries to be checked. It has been found however that using one PID controller to equilibrate pressures in more than two channels is prohibitively time consuming. Therefore, in embodiments of the testing system 44 that are to be used with more complex heat exchangers, a different approach is taken. This is to expand the capabilities of the testing system by using master and slave testing systems, as illustrated in FIGS. 7c and 8c.

A generic single-pass two-section heat exchanger 78 is shown in FIG. 7a and its schematic representation for use in flow control diagrams is shown in FIG. 7b. The heat exchanger 78, shown in side-representation, has a heating section 80 and cooling section 82. Each section 80, 82 has a respective boundary that is provided by an array of thin metal plates that define respective parallel arrangements of channels 84, 86. Within the heat exchanger 78, a product line (product flow path) 88 extends from a product input 90, through a first set of alternate channels 84 in the heating section 80 through a connecting line to the cooling section 82 where it passes through a second set of alternate channels 86 to a product exit 94. In the heating section 80, a heating fluid passage extends from a heating input 96, through the first set of alternate parallel channels 84 to a heating fluid output 98. In the cooling section, a cooling fluid passage extends from a cooling input 100, through the second set of alternate parallel channels 86 to a cooling fluid output 102. Within the first 84 and second 86 sets of alternate channels a physical boundary provided by the plates retains a physical separation but allows thermal contact to be made between the product and, respectively, the heating and cooling fluids. That is, in the heating section 80, the product is heated by heat transfer from the heating fluid and in the cooling section 82, the product is cooled by heat transfer away from the product. This design of heat exchanger may be used, for example, in applications in which a product is cooked or sterilised and then has to be cooled for packaging. Multiple sections also enable re-use of energy: a post heating-process product being used to pre-heat product that is entering the heating process.

FIG. 7b is a schematic representation of a two-section heat exchanger 104. Each section 106, 108 is represented by a rectangular box and the flow paths within are indicated by internal V-shaped lines 110a, 110b, 110c, 110d that extend outside the boxes to indicate connecting flow paths outside the heat exchanger sections 106, 108. This schematic 104 represents a heat exchanger that consists of a heating section 106 and a regeneration section 108 that reuses energy in order to heat a product with improved efficiency. There is one heating fluid flow path 110d extending within the heating section 106 from a heating fluid input 112 to a heating fluid output 114. Remaining flow paths 110a, 110b, 110c are all connected. A product path extends from a product input 116 to the regeneration section 108 along pre-heat path 110a until it leaves the regeneration section 108 at a connecting passage 118. The product path continues into the heating section 106 and passes along path 110c where it comes into thermal contact with fluid in the heating flow path 110d. The heated product then follows return path 120 back to the regeneration section, which on its second pass 110b is on the other side of the section boundary. In this section 108, heat energy from the now cooling product is transferred to product entering the heat exchanger on the pre-heat path 110a and so is used to provide a degree of pre-heating. The product line exits the heat exchanger at a product exit 122.

Exemplary connections to be made between a testing system in accordance with this invention and a heat exchanger of the type represented by the schematic of FIG. 7b are indicated in the Figure. Shut-off valves 124a, 124b, 124c, 124d are fitted at the heat exchanger inputs 112, 116 and exits 114, 122. Respective connection points \textcircled{1}, \textcircled{2}, \textcircled{7}, \textcircled{8} are then established to the heat exchanger side of each shut-off valve, which, in this example, are in three 110a, 110b, 110d of the four heat exchanger lines. It is noted that while connection points \textcircled{1} and \textcircled{2} are located at the input and output of a single path through a single section of the heat exchanger, connection points \textcircled{7} and \textcircled{8} are not. Linking these connection points \textcircled{7} and \textcircled{8} with a single channel of a testing system 44 would enable detection of a leak somewhere within the three heat exchanger paths that extend between these connection points \textcircled{7} and \textcircled{8}, but it is not possible to further localise such a leak. For his reason, additional connections and valves are necessary in a multi-section heat exchanger. Ideally, access will be available to all connectors that link a path through the first section of the heat exchanger with a path through the second section. That is, for the example of FIG. 7b, to the connecting passage 118 and to the return path 120. If such access is available, then a shut off valve 126a, 126b is incorporated in each respective passage along with two connection points \textcircled{5}, \textcircled{6}; \textcircled{3}, \textcircled{4}: one to either side of the valve. In this way each valve 126a, 126b isolates that part of the connecting path that extends through the first section 106 of the heat exchanger from the part that extends through the second section 108. The additional connection points \textcircled{5}, \textcircled{6}; \textcircled{3}, \textcircled{4} that are made available within each part of the connecting path allow the testing system 44 to be connected such that each side of the heat exchanger in each section 106, 108 may be addressed in turn. For example, path 110c that carries the product through the heating section 106 of the heat exchanger may be isolated by closing valve 126a in the connecting passage 118 and valve 126b in the return path 122. A leak within this heat exchanger path 110c may be identified by connecting one channel of a testing system 44 to connection points \textcircled{3} and \textcircled{5}. Similarly, with the valve 126a in connecting passage 118 closed along with that 124c on the product input 116, a leak in the product path 110a on its first passage through the heat exchanger may be detected and localised by connecting one channel of a testing system 44 to connection points \textcircled{6} and \textcircled{7}. Clearly the heating flow path 110d may be tested by linking a channel to connection points \textcircled{1} and \textcircled{2}. Similarly, the path 110b for the second product passage through the regeneration side may be tested through connection points \textcircled{4} and \textcircled{8}.

A testing system 144 in accordance with this invention and that is suitable for testing a two-section heat exchanger of the type depicted in FIG. 7b is illustrated in FIG. 7c. In this embodiment, the testing system 144 comprises a master system 146a and a slave system 146b. Hydraulic components 148a, 148b of the master 146a and slave 146b are identical to each other and also to the hydraulic components 44a of the embodiment of the testing system described with reference to FIGS. 2 and 4. That is, each master 146a and slave 146b has two testing channels that are connectable to flow paths within a heat exchanger whose integrity is to be tested. These channels are indicated on the master 146a by connection labels \textcircled{1}, \textcircled{2}, \textcircled{4}, \textcircled{8} an on the slave 146b by connection labels \textcircled{3} \textcircled{5}, \textcircled{6}, \textcircled{7}. This arrangement corresponds with the labelling of connection points used on FIG. 7b: a connection is made from connection point \textcircled{1} of the testing system 144 to connection point \textcircled{1} on the heat exchanger in order to carry out a heat exchanger test. Further, each master 146a and slave 146b has its own power and water supply, network connection, drainage facility and connection to atmosphere. Where these systems 146a, 146b differ is in their control components and software.

Control components of the master system 146a are the same as those 44b of the previously-described testing system 44. They comprise a power supply unit 66, a testing system management unit (SMU) 67, a switch 68, firewall 69 and a GPIO unit 70. As with the stand-alone unit previously described, the SMU 67 is responsible for the overall management of the testing system 144 and the GPIO unit 70 is primarily responsible for establishing and maintaining pressure in the two testing channels of the master system 146a, using the master GDFS 46 and the previously-described PID algorithms.

Control components of the slave system 146b include all the above components of the master system with the exception of the system management unit 67 and firewall 69. The switch 68 is also removed, unless the system is set up with multiple slave systems. In particular, the slave 146b includes its own GPIO unit 150. The slave GPIO unit 150 is responsible for PID control of pressure setting in the two testing channels of the slave system 146b with the slave GDFS. In addition, the slave GPIO unit 150 reports back sensor data to the SMU 67 of the master system 146a.

In other words, each slave system 146b is capable of establishing and maintaining pressure in its inflow and outflow channels but this is subservient to pressure requests provided by the master SMU 67. Furthermore, all processing of user commands and setting up of test parameters, including the sequence in which testing valves are opened and closed during test procedures, is performed by the SMU 67 located in the master for both master 146a and slave 146b units.

Each master 146a and slave 146b system has two test channels that each may be connected to test one flow path in a heat exchange system. A single master and slave combination is therefore sufficient to run a complete test for leak detection and localisation of a two-stage heat exchanger as represented in FIG. 7b—one channel being connected to each pair of connection points identified above.

Although the slave 146b system has two test channels, there will be applications in which the second channel is unnecessary: for example in testing a heat exchanger with three internal fluid paths. In this case, valves V2.2, V3.2 in one channel will remain closed and the differential between the target pressures at flow channel sensors G3.1, G3.2 can be zero.

This procedure can be extended to more complex heat exchangers, for example the three-section multi-pass plate heat exchanger 160 illustrated in FIGS. 8a and 8b. There are two paths through each section of the heat exchanger and so to isolate each path individually, a total of 12 connections will be required and 6 channels within the testing system 144. In order to test this type of heat exchanger, a master system 146a will be required to be linked to two slave systems 146b, 146c, as indicated in FIG. 8c.

This type of heat exchanger is often used in pasteurisation applications in which there are separate product heating and cooling loops and a recovery section between the two. Although it is noted that the ideal scenario would enable 12 connections to be made between this type of heat exchanger and the testing system of this invention, in practice such access may not be possible and so the testing system will have to be connected with fewer than the ideal number of connections. This would mean that not all paths within each section could be individually isolated and tested. Leak detection would still be possible, but localisation would be less effective.

It should be apparent to one skilled in the art that the principle of using one master system 146a and a number of slave systems 146b, 146c can be scaled up to test accurately the integrity of any heat exchanger system of any complexity. The number of slave systems needed would depend on the number of connection points that are required and accessible.

As will be understood from the above description, the testing system 44 of this invention is capable of providing accurate measurement of flow rates, of the order of a few microlitres per minute. However, a leak out of the heat exchanger system, for example from a valve within a heat exchanger channel, will be indistinguishable from an internal leak within the testing system 44 itself. For this reason, in many applications, the testing system 44 is arranged to carry out a self test before and possibly after the integrity test of a heat exchanger. Moreover, there is also the possibility of a leak developing within the shut off valves 42a, 42b, 42c, 42d that are used to isolate the heat exchanger from the industrial process plant in which it is incorporated. If any leaks were to develop here, this would also result in flow being observed in the testing system.

In some applications therefore, the testing system 44 of this invention may be configured to carry out an additional test on the integrity of these shut off valves 42a, 42b, 42c, 42d. With reference to FIG. 9, there is shown a schematic illustration of a heat exchanger 10, 28 with shut off valves 42a, 42b, 42c, 42d that are operable to isolate the heat exchanger 10, 28 in preparation for an integrity test. In order to test the integrity of these valves, testing valves 150a, 150b, 150c, 150d are placed in each input 16, 22 and output 20, 26 line of both flow paths, to the opposite side of the shut off valves 42a, 42b, 42c, 42d from the heat exchanger 10, 28 that they isolate. Connection points \textcircled{5}, \textcircled{6}, \textcircled{7}, \textcircled{8} are established in each line 16, 20, 22, 26 between the shut off valves 42a, 42b, 42c, 42d and the testing valves 150a, 150b, 150c, 150d.

A testing system 144 of the type shown in FIG. 7c is connected to the connection points \textcircled{1} through \textcircled{8}. The master system 146a is arranged to carry out an integrity test on the heat exchanger 10, 28 by connecting its channels to connection points \textcircled{1}, \textcircled{2} \textcircled{3} and \textcircled{4}. At the same time, channel 1 of the slave system is connected to connection points \textcircled{5}, \textcircled{6} and channel 2 to connection points \textcircled{7}, \textcircled{8}. In order to illustrate the testing procedure in this scenario, consider, for example, that the master system 146a detects flow out of its channel 1, which is connected to connection points \textcircled{1} and \textcircled{2}. If there is a leak at the shut off valve 42b between connection points \textcircled{2} and \textcircled{6}, then this would result in a flow into the slave system 146b at connection point \textcircled{6}. This would be detected as flow within the outflow path 54 of the slave channel 1 and detection at flow sensor F2.1. If, on the other hand, there is a leak at the shut off valve 42a between connection points \textcircled{1} and \textcircled{5}, then flow would enter the slave system 146b at connection point \textcircled{5}. This would be detected by flow sensor F1.1 as flow within the slave system 146b inflow path 52. As the master system 146a detects a leak out of channel 1 therefore, opening and closing valve V4.1 in the slave system 146b enables tests for a corresponding inflow through either connection point \textcircled{5} or \textcircled{6} to be carried out in sequence. If inflow is observed through connection point \textcircled{5}, there is a leak through shut off valve 42b; if it is observed through connection point \textcircled{6}, there is a leak through shut off valve 42a. If no flow is observed through the slave system 146b, then the leak detected by the master system 146a is due to a heat exchanger defect, rather than a defect in a shut off valve. In a similar manner, the remaining shut off valves 42c, 42d can be tested as potential causes of any leaks detected by the master system 146a from its channel 2.

FIG. 10 shows a schematic representation of a different design of heat exchanger 154, illustrating another application of the testing apparatus of this invention. This heat exchanger 154 includes an air conditioning cassette 155 and only a single conduit 156 that exchanges thermal energy with the external environment (air). A fan 158 blows air over the conduit 156 in order to increase the airflow over the heat exchanger boundary. In this example, the heat exchange fluid is R32 refrigerant gas. This gas is constantly changing state between its liquid and gaseous phase depending on the pressure applied at particular stages of the refrigeration cycle. R32 may be considered a harmful substance in enclosed spaces and so it is important to ensure that the heat exchanger 154 is free from leaks.

In preparing the heat exchanger 154 for leak testing using the testing system 44 in accordance with this invention, shut off valves 160a, 160b are installed in the input and output of the conduit 156. Connection points \textcircled{1}, \textcircled{2} are then established in the conduit 156 to the heat exchanger side of the shut-off valves This is similar to the preparation required for the test of previously described heat exchangers 10, 28. In this application however, two further shut off valves 162a, 162b are installed in the conduit 156 input and output respectively. The further shut off valves 162a, 162b are placed to the opposite side of the shut off valves 160a, 160b from the heat exchanger 154. A connection point \textcircled{3}, \textcircled{4} is established in each of the input and output of the conduit 156 between the shut off valve 160a, 160b and its respective further shut off valve 162a, 162b.

In order to test this heat exchanger 154, channel 1 of the testing system 44 is connected to connection points \textcircled{1} and \textcircled{2} channel 2 to connection points \textcircled{3} and \textcircled{4}. Initially, the standard test procedure described above is followed, with additional pressure monitoring at the channel 2 pressure sensors G1.2, G2.2. When the system is pressurised, the channel 1 valves V2.1, V3.1 are opened in order to check for flow through flow sensor F1.1 (see FIG. 2) and the channel 1 inflow path 52. If no flow is detected, then there is no leak from the heat exchanger 154. If, on the other hand, flow is detected at flow sensor F1.1, this may be indicative of a possible leak of refrigerant gas from the conduit 156. In order to verify this, the channel 2 pressure sensor readings are noted and compared.

To proceed, the channel 2 valves 2.2, 3.2 are opened and a check is carried out for any flow along the channel 2 outflow path 58. If there is no flow along these paths and the pressure sensor readings in this path are unchanged, this indicates that the shut off valves 160a, 160b are sound and do not permit flow from channel 2 along the conduit 156. It therefore follows that all flow observed in channel 1 is as a consequence of a leak across the conduit boundary. That is, there is an escape of refrigerant gas.

If, on the other hand, flow is observed on flow sensor F2.2, then there is clearly a flow through the shut off valves 160a, 160b, which may be present with or without a flow across the conduit boundary. In order to characterise the flow that is observed in the channel 1 test channel, the flow in this path (measured at flow sensor F1.1) is compared with that observed on the channel 2 outflow path using flow sensor F2.2. The channel 2 reading represents the flow through the valves 160a, 160b and the difference between the channel 1 and 2 readings (F1.1-F2.2) is the flow across the boundary. If there is no difference, there is no flow across the boundary. Returning now to the channel 2 pressure readings that were taken using sensors G1.2, G2.2 prior to opening the channel 2 valves V2.2, V3.2. In this situation, any pressure observed at sensor G1.2 will be as a result of inflow through connection point \textcircled{3}, as all other valves in the channel remain clothes. Similarly, any pressure observed at sensor G2.2 will be as a result of inflow through connection point \textcircled{4}. Comparison of these two readings, allows for the total flow through the valves (observed on sensor F2.2) to be apportioned to each shut off valve 160a, 160b.

Another application of the apparatus of this invention is in the detection of air voids. Air trapped in a system has a knock-on effect to the efficiency of a production system and so it is advantageous to detect and then remove them. As the integrity test is initiated, the heat exchanger paths 38, 40 are charged with fluid up to an initial starting pressure. Monitoring the volume of fluid that flows past a sensor each time the test is initiated, enables a standard charging volume for that heat exchanger to be determined. If on a subsequent test sequence, it is noted that, based on flow rate and time taken to achieve test condition, a smaller volume of water is required, the discrepancy in volume may be attributed to an air gap. Its detection then allows further investigation to be carried out.

1. A leak testing apparatus comprising:
a first channel with an inflow path and an outflow path that are connectable to spatially separated locations in a first conduit to form a first closed loop system;
a second channel with an inflow path and an outflow path that are connectable to spatially separated locations in a second conduit to form a second closed loop system;
a flow control system including a flow controller in communication with a pump and pressure sensor, the flow control system being in fluid communication with the first and second channels and adapted to pump fluid at a rate that actively maintains pressure at or near a pre-determined level within the first and second closed loop systems; and
a first flow sensor located in the inflow path of the first channel and a second flow sensor located in the inflow path of the second channel.

2. The leak testing apparatus as claimed in claim 1, wherein the flow control system includes a proportional valve and the flow controller is configured to adjust a control voltage applied to the pump and a degree of opening of the proportional valve in response to a signal received from the pressure sensor in order to maintain pressure in the first and second closed loop systems.

3. The leak testing apparatus as claimed in claim 2, that further includes:
a first channel proportional valve and a first channel pressure sensor located in the inflow path of the first channel;
a second channel proportional valve and a second channel pressure sensor located in the inflow path of the second channel; and wherein
the flow controller is configured to adjust a degree of opening of the first channel proportional valve in response to signals received from the pressure sensor and the first channel pressure sensor in order to maintain pressure at or near a first pre-determined level within the first closed loop system;
the flow controller is further configured to adjust a degree of opening of the second channel proportional valve in response to signals received from the pressure sensor and the second channel pressure sensor in order to maintain pressure at or near a second pre-determined level within the second closed loop system; and
the first pre-determined level is different from the second pre-determined level, whereby a pressure differential is maintained between the first and second conduits.

4. The leak testing apparatus as claimed in claim 3, that further includes a third flow sensor located in the outflow path of the first channel and a fourth flow sensor located in the outflow path of the second channel.

5. The leak testing apparatus as claimed in claim 1, further including a respective shut-off valve in each inflow and outflow path.

6. The leak testing apparatus as claimed in claim 1, wherein the first and second conduits are first and second flow paths of a heat exchanger that are adapted for transfer of thermal energy between fluids therein.

7. The leak testing apparatus as claimed in claim 1, wherein the flow controller is a PID controller.

8. The leak testing apparatus as claimed in claim 3, wherein the flow controller includes a microcontroller that is programmed with a PID control algorithm, the flow controller being provided with a first target pressure corresponding to a target pressure to be maintained in the first closed loop system and with a second target pressure corresponding to a target pressure to be maintained in the second closed loop system, the control algorithm having:
a coarse control part that is configured to calculate adjustments of the control voltage applied to the pump and of the degree of opening of the proportional valve in response to the signal received from the pressure sensor, such that said adjustments, when applied to the pump and proportional valve, are adapted to maintain pressure in the flow control system at a value that is a function of the first and second target pressures;
a fine control part that operates when the maintained pressure in the flow control system is within a predetermined amount of its target value and that is configured:
to calculate adjustments of the degree of opening of the first channel proportional valve in response to signals received from the first channel pressure sensor, such that said adjustments, when applied to the first channel proportional valve, are adapted to maintain pressure in the first closed loop system at a value that is within a tolerance range of the first target pressure; and/or
to calculate adjustments of the degree of opening of the second channel proportional valve in response to signals received from the second channel pressure sensor, such that said adjustments, when applied to the second channel proportional valve, are adapted to maintain pressure in the second closed loop system at a value that is within a tolerance range of the second target pressure; and/or
to calculate adjustments to the target value of the coarse control part of the PID control algorithm.

9. The leak testing apparatus as claimed in claim 8, wherein each adjustment is calculated using a PID feedback loop.

10. A leak testing apparatus comprising:
a first channel with an inflow path and an outflow path that are connectable to spatially separated locations in a conduit to form a first closed loop system;
a second channel with an inflow path and an outflow path that are connectable to a second pair of spatially separated locations in the conduit to form a second closed loop system, the second pair of spatially separated locations spanning the first pair of spatially separate locations that are connectable to the first channel;
a flow control system including a flow controller in communication with a pump and pressure sensor, the flow control system being in fluid communication with the channel and adapted to pump fluid at a rate that actively maintains pressure at or near a pre-determined level within the first and second closed loop systems; and
a first flow sensor located in the inflow path of the first channel and a second flow sensor located in the outflow path of the second channel; whereby
the leak testing apparatus is capable of detecting leakage through valves that may be located in the second closed loop system but not the first.

11. The leak testing apparatus as claimed in claim 10, wherein the apparatus also includes a first pressure sensor located in the inflow path of the second channel and a second pressure sensor located in the outflow path of the second channel.

12. A leak testing system comprising:
a first testing apparatus as claimed in claim 1, the first testing apparatus being connectable to first and second conduits;
a second testing apparatus as claimed in claim 1, the second testing apparatus being connectable to third and fourth conduits to form third and fourth closed loop systems; and
a system management unit configured to provide the first testing apparatus with the pre-determined levels at which pressure is to be maintained in the first and second closed loop systems and to provide the second testing apparatus with the pre-determined levels at which pressure is to be maintained in the third and fourth closed loop systems.

13. The leak testing system as claimed in claim 12, and in which respective shut-off valves are located in each inflow and outflow path of each testing apparatus and wherein the system management unit is configured to provide signals to the shut-off valves in both testing apparatus that open and close said shut-off valves in a sequence in accordance with a leak test to be carried out.

14. The leak testing system as claimed in claim 13, wherein the system includes a third testing apparatus as claimed in claim 1, the third testing apparatus including shut-off valves located in each inflow and outflow path and being connectable to fifth and sixth conduits to form fifth and sixth closed loop systems; and wherein the system management unit is further configured to provide signals to the shut-off valves in the third testing apparatus that open and close said shut-off valves in a sequence in accordance with a leak test to be carried out.

15. The leak testing system as claimed in claim 12, wherein the first, second, third, fourth and, if applicable, fifth and sixth conduits each correspond to a flow path in a heat exchanger wherein thermal energy may be transferred between one or more pairs of flow paths.

16. A method of testing a fluid conduit with valves for leaks, a valve-free first section of the fluid conduit being connected to inflow and outflow paths of a first channel of a leak testing apparatus to form a first closed loop system and a second section of the fluid conduit that spans the first section and also at least one valve being connected to inflow and outflow paths of a second channel of a leak testing apparatus to form a second closed loop system, the method comprising:
a) Pumping fluid through a flow control system to charge the first and second closed loop systems to a pre-determined pressure level;
b) Operating the flow control system to maintain fluid pressure in the first and second closed loop systems at said pre-determined pressure level; and
c) Using a first flow sensor to measure fluid flow rate through the inflow path of the first channel and a second flow sensor to measure fluid flow rate through the outflow path of the second channel.

17. A method of testing a heat exchanger for leaks between first and second fluid conduits, the conduits being arranged in the heat exchanger to enable transfer of thermal energy between fluids therein, the method comprising:
a) Placing the first fluid conduit in fluid communication with a first channel within a testing system, the first channel comprising a first inflow path and a first outflow path, the first conduit and first channel thereby forming a first closed loop system;
b) Placing the second fluid conduit in fluid communication with a second channel within the testing system, the second channel comprising a second inflow path and a second outflow path, the second conduit and second channel thereby forming a second closed loop system;
c) Pumping fluid through a flow control system that is in fluid communication with the first and second inflow paths;
d) Adjusting a first proportional valve in the flow control system, a second proportional valve in the first inflow path and a third proportional valve in the second inflow path such that first and second pre-determined fluid pressures are reached in respective first and second channels, wherein the pre-determined fluid pressure in the first channel is greater than that in the second channel;
e) Maintaining pressure in the first and second channels while closing first, second, third and fourth shut-off valves in the respective first inflow, first outflow, second inflow and second outflow paths;
f) While continuing to maintain pressure in the first and second channels:
i) Opening first shut-off valve and using a first flow sensor to measure flow in the first inflow path;
ii) Opening fourth shut-off valve and using a second flow sensor to measure flow in the second outflow path; whereby
iii) Observing flow in the first inflow path that is above a tolerance level is indicative of a leak from the first conduit and observing flow in both paths that is above a tolerance level is indicative of a leak between the first and second conduit.

18. The method as claimed in claim 17, including the additional steps of:
g) While continuing to maintain pressure in the first and second channels:
i) Opening third shut-off valve and using a third flow sensor to measure flow in the second inflow path; whereby
ii) Observing flow in the second inflow path that is above a tolerance level is indicative of a leak from the first conduit.

19. A PID controller adapted to maintain pressure within a hydraulic or pneumatic system that comprises:
a flow control system with a pump, pressure sensor and proportional valve;
a first closed loop system that is in fluid communication with the flow control system and includes a first channel proportional valve and a first channel pressure sensor; and
a second closed loop system that is in fluid communication with the flow control system and includes a second channel proportional valve and a second channel pressure sensor; wherein
the PID controller is adapted to apply a variable control voltage to the pump and to adjust the degree of opening of the proportional valve and first and second channel proportional valves; and comprises
a coarse control part; and
a fine control part; wherein
the PID controller is adapted to apply adjustments of the control voltage applied to the pump and of the degree of opening of the proportional valve in response to a signal received from the pressure sensor, said adjustments being calculated by the coarse control part to maintain pressure in the flow control system at a target value that is a function of a first and second target pressures; and
when the pressure sensor indicates a pressure value that is within a predetermined amount of the target value, the PID controller is adapted to:
apply adjustments of the degree of opening of the first channel proportional valve in response to signals received from the first channel pressure sensor, said adjustments being calculated by the fine control part to maintain pressure in the first closed loop system at a value that is within a tolerance range of the first target pressure; and/or
apply adjustments of the degree of opening of the second channel proportional valve in response to signals received from the second channel pressure sensor, said adjustments being calculated by the fine control part to maintain pressure in the second closed loop system at a value that is within a tolerance range of the second target pressure; and/or
adjust the target value of the coarse control part that is a function of the first and second target pressures.
